(19) United States
(12) Patent Application Publication
(10) Pub. No.: US 2014/0194177 A1
(43) Pub. Date: Jul. 10, 2014

(54) GAME WITH PARAMETERS AND VARIABLES CORRESPONDING TO UNITS OF TIME

(71) Applicant: Ahmnon D. MOSKOWITZ, Rockville, MD (US)

(72) Inventor: Ahmnon D. MOSKOWITZ, Rockville, MD (US)

(21) Appl. No.: 14/150,758

(22) Filed: Jan. 8, 2014

Related U.S. Application Data
(60) Provisional application No. 61/750,350, filed on Jan. 8, 2013.

(51) Int. Cl. A63F 13/30; A63F 3/06

(52) U.S. Cl. CPC A63F 13/12; A63F 3/065
USPC 463/16; 273/138.1

(57) ABSTRACT

A game of chance, a ticket for a game of chance, and a method of playing and operating a game of chance are provided. The game includes a plurality of parameters, each parameter representing a unit of time, and each parameter including a separate matrix with variables representing a subunit or a point of time contained within the parameter. The game of chance is configured such that a player selects one or more player variables within at least one of the parameters, and a gaming operator draws one or more operator variables from a same set of the parameters and a same set of the variables within the parameters. If the player variables selected by the player matches the operator variables selected by the operator, then a corresponding payout is awarded.

### CROSS-REFERENCE TO RELATED APPLICATIONS

This application is a non-provisional Application, for which priority is claimed under 35 U.S.C. §119, of copending U.S. Provisional Patent Application No. 61/750,350, filed Jan. 8, 2013, and entitled “GAME WITH PARAMETERS AND VARIABLES CORRESPONDING TO UNITS OF TIME,” the entire contents of the above identified patent application is hereby incorporated by reference in its entirety.

### FIELD OF THE INVENTION

The present invention is directed to a game of chance, and more particularly, to a game of chance including one or more parameters and variable related to units of time, and more particularly, to a game of chance for lottery, video or casino outlets. This game comprises parameters and variables, each parameter relates to units of time such as: days, months, years, or astrological signs. There are variables in each parameter representing the subunits of the parameter. Winning variables within the parameters are selected by the game operator. If the player's variable(s) match the variable(s) drawn by the game operator a corresponding payout is awarded. This game can be played as a casino type game, a video lottery type game, or a government sponsored lottery game.

### BACKGROUND OF THE INVENTION

A conventional lotto game in the United States may involve a plurality of parameters and a plurality of variables within the parameters. Generally, the variables range from zero or one to X. The odds of winning the top prize can be altered by increasing the parameters and making X a larger or smaller number. The “pick 3” and “pick 4” are examples of conventional lottery number games. In these examples, three or four digits are chosen, and the lottery system picks the winners. If the player's numbers match the lottery's numbers in exact order, a top prize is won. Other features include a system where a player can match the two front digits, the two back digits, the first and last digit, or some combination of the above. Other conventional lottery games include, for example, the “mega millions” and “multi match” in which six (6) numbers are drawn and, if a player matches all of the numbers, then the player is awarded a grand prize, or the player is awarded subordinate prizes for matching part of the numbers.

Conventional examples of various means in which the lottery system can be automated are described in U.S. Pat. Nos. 4,494,197, 4,689,742, 4,323,770, 4,277,064, 4,033,588, which are incorporated herein by reference in their entirety. An example of a lottery game with a plurality of parameters and variables is described in U.S. Pat. No. 7,662,038, which is incorporated herein by reference in its entirety. Examples of video lottery systems are described in U.S. Pat. Nos. 6,168,521 and 5,380,007, which are incorporated herein by reference in their entirety. An example of one of many means in which the conventional game systems select winners is described in U.S. Pat. No. 5,511,784, which is incorporated herein by reference in its entirety. An example of a numbers game is described in U.S. Pub. No. 2004/0173965, which is incorporated herein by reference in its entirety. An example of a lottery number selector where a player inputs a specific date and a lottery number is chosen for the player to play is described in U.S. Pat. No. 5,118,110, which is incorporated herein by reference in its entirety. In an example of a calendar based game, which is described in U.S. Pat. No. 6,802,506, which is incorporated herein by reference in its entirety, and which is similar to U.S. Pat. No. 5,118,110, a player can choose an entry number based on a specific point of time; however, the chosen numbers generally do not correspond to a specific moment time. Another drawback is that many points share multiple points of time.

### SUMMARY OF THE INVENTION

As explained above, the present invention is directed to a game of chance, and more particularly, to a game of chance including one or more parameters and variable related to units of time, and more particularly, to a game of chance for lottery, video or casino outlets. The exemplary embodiments are directed to a game comprising parameters and variables, each parameter relating to units of time such as, for example, days, months, years, or astrological signs. Each parameter can include variables representing one or more subunits of the parameter. Winning variables within the parameters can be selected by the game operator. If a player's variable(s) match the variable(s) drawn by the game operator, a corresponding payout is awarded. The exemplary embodiments of the game can be played as a casino type game, a video lottery type game, or a government sponsored lottery game.

The present invention recognizes that many times players pick numbers based on dates that the player feels have some significance to them. The conventional art contains games that contain parameters and variables that are inconsistent with time units. For example, in Powerball®, if a player wants to choose a month, the player may pick 12; however, since there are 56 numbers a player might have a sense of inequity. If a player wants a year like 1993, the player also will have to use some other form of substitute since the number 93 is not available. The pick 4 has a better compatibility with dates since there are four parameters with variables {0 to 9}. Accordingly, a player can pick variables based on months or days, {, 01, 02, 03 . . . , 10, 11, 12} and {1, 2, 3 . . . 29, 30, 31}. However, a drawback with the Pick 4 format is that there is a great deal of excessive variables unrelated to most dates.

The present invention solves these and other problems by providing a game of chance, and a method of providing such a game of chance and playing such a game of chance, that includes parameters and variables corresponding with units of time, wherein a game operator selects winners from the same parameters and variables.

Herein described are exemplary embodiments of a game of chance adapted to be played in relation to units of time. The exemplary embodiments of the game can be played by anyone, but more specifically, the game can be geared towards players who feel the need to pick numbers based on specific dates. For example, the most popular time units may include days, months, years, and/or zodiacs.

More particularly, an exemplary embodiment of the present invention includes a game of chance in which selections are made from a plurality of parameters. The parameters each represent a specific unit(s) of time. A player can either pick the variable(s) within the parameter(s) or choose to have a computer select them (e.g., a lottery computer). Each parameter can represent a unit of time and variables in each parameter can represent different point(s) within that parameter.

The units can be correlated to the Gregorian calendar, but are not limited to any particular calendar. For example, other embodiments can include The Chinese, Jewish, Indian, Korean, Vietnamese, and/or Japanese calendars. In still another embodiment, the game can be linked to zodiac signs. In another alternative embodiment, the game can include time parameters representing, for example, minutes, hours, and/or weeks.

The month parameters generally include {1-12} and can represent the variables {January, February, March, April, May, June, July, August, September, October, November, December}. However, these parameters are not limited and can differ for non-Gregorian calendars. The day of the month parameter generally includes variables {1-31}. Another parameter can include a year parameter, with each year representing a variable. In other embodiments, it would be possible to have around 2000; however, the present invention recognizes that this may diminish the sensual feel of a player. The present invention recognizes that having fewer variables would increase a player's chance of winning In one exemplary embodiment, a player has the option of selecting variable(s) from within a plurality of year parameters. In each game, the operator can draw separate variables from each parameter. For example, an exemplary game can have a unit of Years 1900 to 2014, and the unit can be divided into three (3) parameters, such as for example {1900 to 1938}, {1939 to 1976}, and {1977 to 2014}. The game operator can select a variable from each of the three (3) separate parameters. In other embodiments, the year units also can be divided into, for example, half, fourths, fifths, and so forth. In an alternative embodiment, the year unit can be a sole parameter and multiple variables can be chosen from that parameter.

In another exemplary embodiment, a parameter can contain units within that represent a plurality of points of time. For example, the points of time [1901, 1929, 1957, 1985] can represent a single selection. In another example, the days [28, 29] can be a single selection.

According to the exemplary embodiments, a player can have several ways to play, including but not limited to 1) exact date, 2) show, 3) exact date/show combination, and 4) multi-date combination.

The selection of winning numbers can be provided in various ways. In an example, a gaming operator can only select specific variables that exist. For example, the variables April and June cannot co-exist with a variable representing the 31^{st} day. If a game is played with year parameters, then a date such as February 29^{th} can only appear with a leap year like 2004, or 2008. If a player makes an incorrect selection, such as September 31^{st}, then the selection will be regarded as an invalid selection by the gaming operator. The winning numbers can be chosen mechanically, manually, or by a computer.

Another parameter that is common in conventional state lotteries that can be used in conjunction with the exemplary embodiments of the invention is the multiplier. In this example, a player can mark (or select) the “multiplier option,” increasing their wager amount. A computer then can select a multiplier and any winnings by the player will be increased by the multiplier factor.

The payout based on winning numbers can be provided in various ways. In one or more of the exemplary embodiments, for payouts, a game operator can have the choice of having a payout for matching the exact variables or having subordinate prizes for matching part of the winning variables. For example, if a player picks day/month/year to win, then a rule can be written to award a player that matches two out of three. The payout can vary depending on how the game operates. For example, for a day in a year, the probability of winning is approximately 1/365. If there are three winners, then the probability of winning will be 3/365, which will increase the odds of winning and reduce the payout. The probability of hitting an exact day/month/year/match is approximately 365*the variables in the year parameter. The payouts for the show option also can vary. For example, the approximate probability of hitting a month is one in 12; slightly less for February and slightly more for the months with 31 days.

The approximate probability for hitting a day variables also vary. For example, February has 28 or 29 days, followed by April, May, June, September, and November having 30 days, and the others consisting of 31 days. In an exemplary embodiment, the lottery operator can prescribe the same payout for matching the day variable. Alternatively, the lottery operator can alter the payouts to correlate to the frequency of occurrence, for example, with {1-28}, {29}, {30}, and {31} each having a different payout. If the operator wants to simplify the payouts system, then the operator can make one payout for the variables {1-30} and another payout for the {31} variable. The probability of the year variable occurring will be approximately the number of variables in the year parameter(s).

The results of the game of chance can be generated in various ways. In the exemplary embodiments, the results can be generated by a computer, drawn manually, or drawn mechanically. In an exemplary lottery version, either a player will select the appropriate criteria or choose to have a computer (e.g., a lottery computer) select them. A teller can enter the bets manually or a player can take a betting slip and mark the indicia, and then the slip can be inputted through a terminal. In the exemplary embodiments, the terminals can either be stand alone, and/or in the case of state lotteries, there can be a multitude of terminals and each terminal can be connected to a centralized computer system.

The input of parameters and selections can be performed in various ways. In an exemplary embodiment, the lottery system can include multiple terminals that send and receive data via a centralized processing unit. The lottery central processor can be connected to a multitude of remote terminals with each terminal having the ability of sending and receiving data inputs to the central processing unit, with such data inputs including the identification of the playing console, the amount played, and the games selected which could be instant game or a delayed game. In an exemplary embodiment, the terminal will either accept or reject the bet, determining if it is valid or not. A ticket identifying the characteristics of the bet would be printed. A means of verifying the validity of the ticket would also be printed on the ticket.

The exemplary embodiments are not limited to any particular combination of parameters, and any combination of parameters including one or more units of time, or fields of one or more parameters including one or more units of time, on a ticket are contemplated within the spirit and scope of the invention. The ticket can include one or more fields of parameters that can be organized in various ways, such as defined, for example, by borders, color, size, etc.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a schematic illustrating a sample bet sheet according to an exemplary embodiment of the invention.

FIG. 2 is a schematic illustrating an alternate form of betting in the year parameter, in which one indicia represents multiple years, according to another exemplary embodiment of the invention.

FIG. 3 is a schematic illustrating examples of astrological signs that can be marked alongside or in place of the time units in FIG. 1, according to another exemplary embodiment of the invention.

FIG. 4 is a schematic illustrating examples of indicia for Chinese time and zodiac symbols, according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

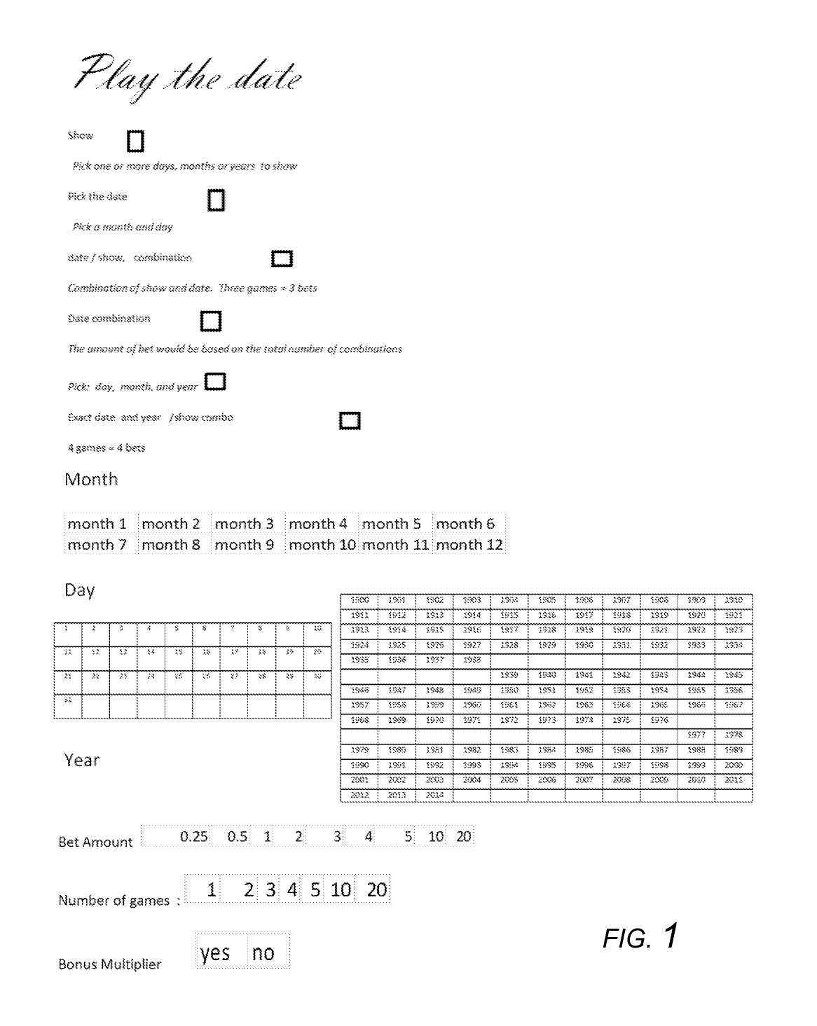

Referring now to the drawings, FIGS. 1-4 illustrate exemplary embodiments of a game of chance, and a method of providing such a game of chance and playing such a game of chance, that includes parameters and variables corresponding with units of time, wherein a game operator selects winners from the same parameters and variables. The exemplary embodiments of the game of chance are adapted to be played in relation to units of time. The game can be played by anyone, but more specifically, the game can be geared towards players who feel the need to pick numbers based on specific dates. For example, the most popular time units may include days, months, years, and/or zodiacs. More particularly, an exemplary embodiment includes a game of chance in which selections are made from a plurality of parameters.

FIG. 1 illustrates an exemplary embodiment of a sample bet sheet. As shown for example in FIG. 1, the parameters each represent a specific unit(s) of time. A player can either pick the variable(s) within the parameter(s) or choose to have a computer select them (e.g., a lottery computer). Each parameter can represent a unit of time and variables in each parameter can represent different point(s) within that parameter. The units can be correlated to the Gregorian calendar, but are not limited to any particular calendar. For example, other embodiments can include The Chinese, Jewish, Indian, Korean, Vietnamese, and/or Japanese calendars. In still another embodiment, the game can be linked to zodiac signs. In another alternative embodiment, the game can include time parameters representing, for example, minutes, hours, and/or weeks.

The month parameters generally include {1-12} and can represent the variables {January, February, March, April, May, June, July, August, September, October, November, December}. However, these parameters are not limited and can differ for non-Gregorian calendars. The day of the month parameter generally includes variables {1-31}. Another parameter can include a year parameter, with each year representing a variable. In other embodiments, it would be possible to have around 2000; however, the present invention recognizes that this may diminish the sensual feel of a player. The present invention recognizes that having fewer variables would increase a player's chance of winning.

With reference again to FIG. 1, in one exemplary embodiment, a player has the option of selecting variable(s) from within a plurality of year parameters. In each game, the operator can draw separate variables from each parameter. For example, an exemplary game can have a unit of Years 1900 to 2014. The unit can be divided into three (3) parameters, such as for example {1900 to 1938}, {1939 to 1976}, and {1977 to 2014}. The game operator can select a variable from each of the three (3) separate parameters. In other embodiments, the year units also can be divided into, for example, half, fourths, fifths, and so forth. In an alternative embodiment, the year unit can be a sole parameter and multiple variables can be chosen from that parameter. In another exemplary embodiment, a parameter can contain units within that represent a plurality of points of time. For example, the points of time [1901, 1929, 1957, 1985] can represent a single selection. In another example, the days [28, 29] can be a single selection.

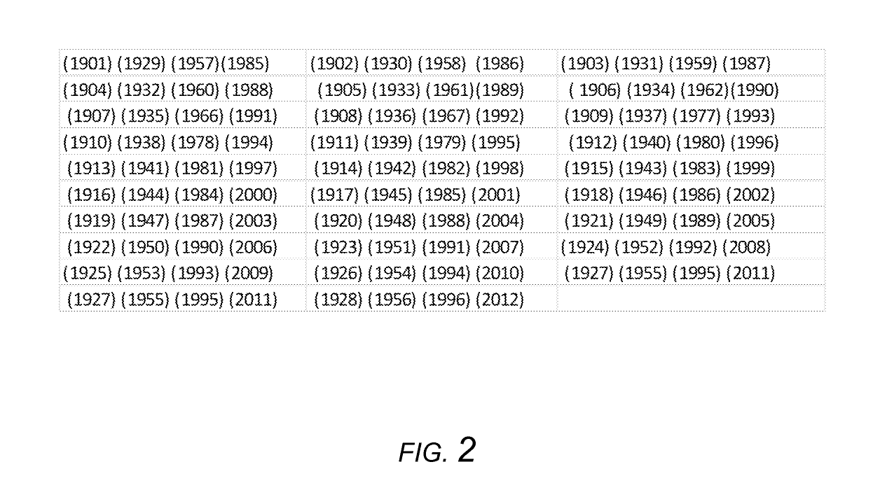

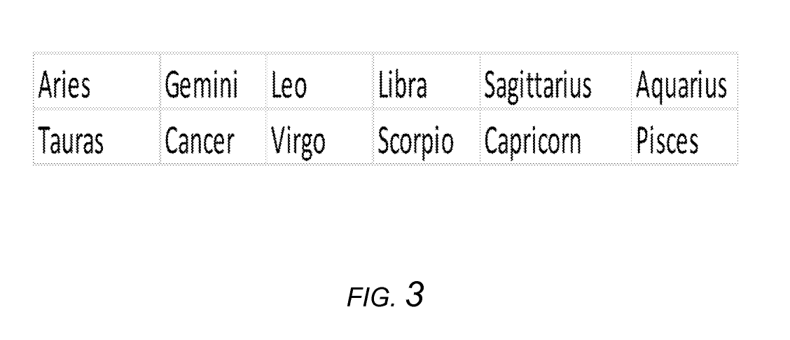

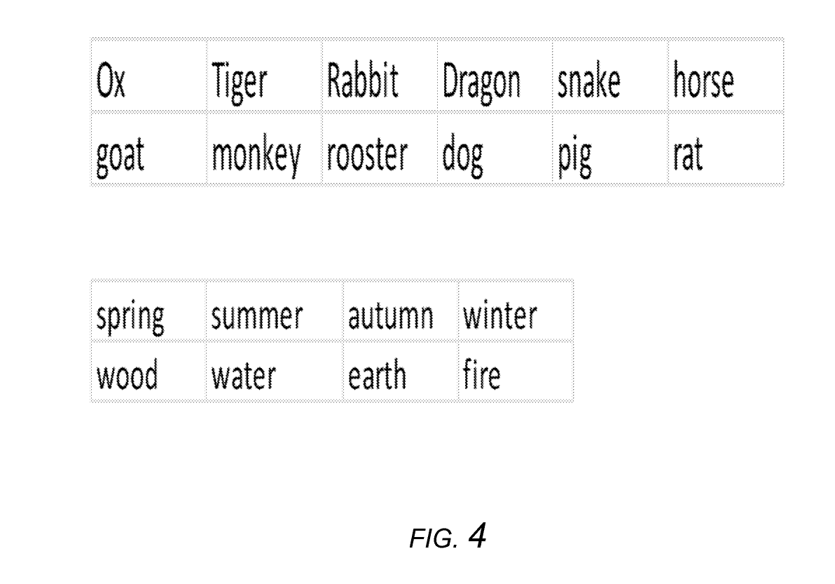

FIG. 2 illustrates an alternate form of betting in the year parameter, in which one indicia represents multiple years. FIG. 3 illustrates examples of astrological signs that can be marked alongside or in place of the time units in FIG. 1, according to another exemplary embodiment. FIG. 4 illustrates examples of indicia for Chinese time and zodiac symbols, according to another exemplary embodiment. The exemplary embodiments are not limited to any particular combination of parameters, and any combination of parameters including one or more units of time, or fields of one or more parameters including one or more units of time, on a ticket are contemplated within the spirit and scope of the invention. The ticket can include one or more fields of parameters that can be organized in various ways, such as defined, for example, by borders, color, size, etc.

According to the exemplary embodiments, a player can have several ways to play, including, for example:
1) Exact date:
In this example, the player or computer (e.g., lottery computer) can pick a plurality of parameters with separate variables and the player wagers that the variables occur in the game simultaneously. For example, the player can pick a specific month, day, and/or a year. More particularly, for example, a player can pick “November 10” and if “November 10” is drawn, then the player will be entitled to the corresponding payout.
2) Show:
The player or computer (e.g., lottery computer) can choose a variable or multiple variables within the parameters. In this example, the player is wagering on a single variable occurring; for example “the month of November” or the “23” of any month” or “1930.” If any of those selected variables are drawn, then the player wins the corresponding prize.
3) Exact date/Show combination:
The player can choose to play a combination of an exact date and a show. For example, if the player selects “September 21”, then the player would be placing three bets, including that:
   a) September will show;
   b) 21 will show; and
   c) both variables “September” and “21” will occur simultaneously.
For example, if February 21 or September 15 shows up (e.g., is drawn), then the player will win the Show game and loose the exact date game. If “September 21” is drawn, then the player will win all three games.
4) Multi-date combination:
This exemplary embodiment is a variation of the “Exact date” option. This involves a game play that will require a plurality of winning variables to win. The player chooses at least one variable in one parameter and a plurality of variables in another parameter. The amount of the bet would be based on the total number of combinations. For example, if a player selects “September” in the month parameter and “23” and “25” in the day parameter, then the player will have made two bets. In this example, the player is wagering that either A) “September 23” or B) “September 25” will be drawn. In another example, a player may mark “September”, “July” and the days “23”, “25” and the years “1980” and “1963.” In this example, the player will be placing six bets since there are a total of six combinations.

### Selection of Winning Numbers

In an exemplary embodiment of the invention, a gaming operator can only select specific variables that exist. For example, the variables April and June cannot co-exist with a variable representing the 31^{st} day. If a game is played with year parameters, then a date such as February 29^{th} can only appear with a leap year like 2004, or 2008. If a player makes an incorrect selection, such as September 31^{st}, then the selection will be regarded as an invalid selection by the gaming operator. The winning numbers can be chosen mechanically, manually, or by a computer.

Another parameter that is common in conventional state lotteries that can be used in conjunction with the exemplary embodiments of the invention is the multiplier. In this example, a player can mark (or select) the “multiplier option,” increasing their wager amount. A computer then can select a multiplier and any winnings by the player will be increased by the multiplier factor.

### Payouts

In one or more of the exemplary embodiments, for payouts, a game operator can have the choice of having a payout for matching the exact variables or having subordinate prizes for matching part of the winning variables. For example, if a player picks day/month/year to win, then a rule can be written to award a player that matches two out of three.

The payout can vary depending on how the game operates. For example, for a day in a year, the probability of winning is approximately 1/365. If there are three winners, then the probability of winning will be 3/365, which will increase the odds of winning and reduce the payout. The probability of hitting an exact day/month/year/match is approximately 365*the variables in the year parameter.

The payouts for the show option also can vary. For example, the approximate probability of hitting a month is one in 12; slightly less for February and slightly more for the months with 31 days.

The approximate probability for hitting a day variables also vary. For example, February has 28 or 29 days, followed by April, May, June, September, and November having 30 days, and the others consisting of 31 days. In an exemplary embodiment, the lottery operator can prescribe the same payout for matching the day variable. Alternatively, the lottery operator can alter the payouts to correlate to the frequency of occurrence, for example, with {1-28}, {29}, {30}, and {31} each having a different payout. If the operator wants to simplify the payouts system, then the operator can make one payout for the variables {1-30} and another payout for the {31} variable. The probability of the year variable occurring will be approximately the number of variables in the year parameter(s).

In the exemplary embodiments, the results can be generated by a computer, drawn manually, or drawn mechanically. In an exemplary lottery version, either a player will select the appropriate criteria or choose to have a computer (e.g., a lottery computer) select them. A teller can enter the bets manually or a player can take a betting slip and mark the indicia, and then the slip can be inputted through a terminal. In the exemplary embodiments, the terminals can either be stand alone, and/or in the case of state lotteries, there can be a multitude of terminals and each terminal can be connected to a centralized computer system.

In an exemplary embodiment, the lottery system can include multiple terminals that send and receive data via a centralized processing unit. The lottery central processor can be connected to a multitude of remote terminals with each terminal having the ability of sending and receiving data inputs to the central processing unit, with such data inputs including the identification of the playing console, the amount played, and the games selected which could be instant game or a delayed game. In an exemplary embodiment, the terminal will either accept or reject the bet, determining if it is valid or not. A ticket identifying the characteristics of the bet would be printed. A means of verifying the validity of the ticket would also be printed on the ticket.

An exemplary embodiment of the invention includes a game of chance comprising a plurality of parameters, wherein each parameter of the plurality of separate parameters represents a unit of time, and wherein each parameter includes a separate matrix with variables representing one of a subunit and a point of time contained within the parameter, wherein a player selects one or more variables within at least one of the plurality of separate parameters, and the gaming operator also draws from the same parameters and from the same variables, wherein if a players selected variable(s) within the selected parameter matches the gaming operators selected variable(s) within the matching parameter(s) a corresponding payout is awarded. In an embodiment, a parameter is a Year and the variables are months within the year. In another embodiment, a parameter represents a month and the variables are days within the month. In yet another embodiment, a parameter includes a plurality of years and the variables are the years within the plurality of years. In still another embodiment, a parameter includes a zodiac and the variables are signs within the zodiac. In another embodiment, the game can include a bonus multiplier. In another embodiment, the game can be conducted by a lottery operator.

Another exemplary embodiment of the invention includes a ticket for a game of chance comprising a plurality of parameters, wherein each parameter of the plurality of separate parameters represents a unit of time, and wherein each parameter includes a separate matrix with variables representing one of a subunit and a point of time contained within the parameter, wherein a player selects one or more variables within at least one of the plurality of separate parameters, and the gaming operator also draws from the same parameters and from the same variables, wherein if a players selected variable(s) within the selected parameter matches the gaming operators selected variable(s) within the matching parameter(s) a corresponding payout is awarded. In an embodiment, a parameter is a Year and the variables are months within the year. In another embodiment, a parameter represents a month and the variables are days within the month. In yet another embodiment, a parameter includes a plurality of years and the variables are the years within the plurality of years. In still another embodiment, a parameter includes a zodiac and the variables are signs within the zodiac. In another embodiment, the game can include a bonus multiplier. In another embodiment, the game can be conducted by a lottery operator. In an exemplary embodiment, the game includes a terminal for inputting indicia. In an exemplary embodiment, the game includes a lottery terminal connected to a network interface to receive or input data. In an exemplary embodiment, the game includes an electronic interface for entering data using, the interface being capable of supplying data by the use of a central processor. In an exemplary embodiment, the game includes a means for identifying, or a device that identifies, the ticket characteristics that are printed on the ticket such as for example an optical device, scanning device, etc. In an exemplary embodiment, the game includes a marker printed on the ticket with means for identifying the validity of a ticket.

Another embodiment of the invention is directed to a method of playing a game of chance comprising a plurality of parameters, wherein each parameter of the plurality of separate parameters represents a unit of time, and wherein each parameter includes a separate matrix with variables representing one of a subunit and a point of time contained within the parameter, wherein a player selects one or more variables within at least one of the plurality of separate parameters, and the gaming operator also draws from the same parameters and from the same variables, wherein if a players selected variable(s) within the selected parameter matches the gaming operators selected variable(s) within the matching parameter(s) a corresponding payout is awarded. In an embodiment, a parameter is a Year and the variables are months within the year. In another embodiment, a parameter represents a month and the variables are days within the month. In yet another embodiment, a parameter includes a plurality of years and the variables are the years within the plurality of years. In still another embodiment, a parameter includes a zodiac and the variables are signs within the zodiac. In another embodiment, the game can include a bonus multiplier. In another embodiment, the game can be conducted by a lottery operator.

In an exemplary embodiment, the method includes inputting the indicia using a terminal. In an exemplary embodiment, a lottery terminal is connected to a network interface, and the method includes receiving or inputting data using the lottery terminal. In an exemplary embodiment, the method includes entering data using an electronic interface, the interface being capable of supplying data by the use of a central processor. In an exemplary embodiment, the method includes identifying the ticket characteristics that are printed on the ticket. In an exemplary embodiment, the method includes identifying the validity of a ticket using a marker that is printed on the ticket.

Another exemplary embodiment of the invention includes a device having a controller that is programmed to control the inputting of parameters for a game of chance, wherein the game of chance comprises a plurality of parameters, wherein each parameter of the plurality of separate parameters represents a unit of time, and wherein each parameter includes a separate matrix with variables representing one of a subunit and a point of time contained within the parameter, wherein a player selects one or more variables within at least one of the plurality of separate parameters, and the gaming operator also draws from the same parameters and from the same variables, wherein if a players selected variable(s) within the selected parameter matches the gaming operators selected variable(s) within the matching parameter(s) a corresponding payout is awarded. In an embodiment, a parameter is a Year and the variables are months within the year. In another embodiment, a parameter represents a month and the variables are days within the month. In yet another embodiment, a parameter includes a plurality of years and the variables are the years within the plurality of years. In still another embodiment, a parameter includes a zodiac and the variables are signs within the zodiac. In another embodiment, the game can include a bonus multiplier. In another embodiment, the device can be controlled or operated by a lottery operator. In an exemplary embodiment, the device includes a terminal for inputting indicia. In an exemplary embodiment, the device includes a lottery terminal connected to a network interface to receive or input data. In an exemplary embodiment, the device includes an electronic interface for entering data using, the interface being capable of supplying data by the use of a central processor.

In an exemplary embodiment, a game of chance includes a plurality of separate parameters, wherein each parameter represents a unit of time, wherein, within each parameter is a separate matrix with variables representing the subunits or points of time contained within, wherein a player selects variable(s) within at least one of the parameters, and the gaming operator also draws from the same parameters and from the same variables, and wherein if a players selected variable(s) within the selected parameter matches the gaming operators selected variable(s) within the matching parameter(s) a corresponding payout is awarded. A parameter can be a Year and the variables can be months within the year. A parameter can represent a month and the variables can be days within a month. A parameter can be a plurality of years and the variables can be the years within the plurality of years. A parameter can be a zodiac and the variables signs within. In other embodiments, a parameter can be any one of the examples described above, or combinations of two or more of the parameters described above.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

The terminology used herein is for the purpose of describing particular embodiments only and is not intended to be limiting of the invention. Well-known functions or constructions may not be described in detail for brevity and/or clarity.

What is claimed is:

1. A game of chance comprising:
a plurality of parameters, wherein each parameter of the plurality of parameters represents a unit of time, and wherein each parameter includes a separate matrix with a plurality of variables representing one of a subunit and a point of time contained within the parameter,
wherein the game of chance is configured such that a player selects one or more player variables within at least one of the plurality of parameters, and a gaming operator draws one or more operator variables from a same set of the plurality of parameters and a same set of the variables within the at least one of the plurality of parameters, and
wherein if the one or more player variables selected by the player matches the one or more operator variables selected by the operator a corresponding payout is awarded.

2. The game of claim 1, wherein a parameter of the plurality of parameters includes a year, and wherein the plurality of variables includes months within the year.

3. The game of claim 1, wherein a parameter of the plurality of parameters includes a month and the plurality of variables includes days within the month.

4. The game of claim 1, wherein a parameter of the plurality of parameters includes a plurality of years and the plurality of variables includes years within the plurality of years.

5. The game of claim 1, wherein a parameter of the plurality of parameters includes a zodiac and the plurality of variables includes signs within the zodiac.

6. The game of claim 1, further comprising a bonus multiplier.

7. The game of claim 1, wherein the game is conducted by a lottery operator.

8. A ticket for the game of chance of claim 1, the ticket comprising:
a printed medium including the plurality of parameters, wherein each parameter of the plurality of parameters represents the unit of time, and wherein each parameter includes the separate matrix with the plurality of variables representing the one of the subunit and the point of time contained within the parameter.

9. A method of playing a game of chance, wherein the game of chance includes a plurality of parameters, wherein each parameter of the plurality of parameters represents a unit of time, and wherein each parameter includes a separate matrix with a plurality of variables representing one of a subunit and a point of time contained within the parameter,
the method comprising:
selecting, by a player, one or more player variables within at least one of the plurality of parameters; and
selecting, by a gaming operator, one or more operator variables from a same set of the plurality of parameters and a same set of the variables within the at least one of the plurality of parameters; and
determining a winner and corresponding payout if the one or more player variables selected by the player matches the one or more operator variables selected by the operator.

10. The method of claim 9, wherein a parameter of the plurality of parameters includes a year, and wherein the plurality of variables includes months within the year.

11. The method of claim 9, wherein a parameter of the plurality of parameters includes a month and the plurality of variables includes days within the month.

12. The method of claim 9, wherein a parameter of the plurality of parameters includes a plurality of years and the plurality of variables includes years within the plurality of years.

13. The method of claim 9, wherein a parameter of the plurality of parameters includes a zodiac and the plurality of variables includes signs within the zodiac.

14. The method of claim 9, wherein the game of chance further comprises a bonus multiplier.

15. The method of claim 9, wherein the gaming operator is a lottery operator.

16. The method of claim 9, further comprising:
inputting the one or more player variables using a terminal.

17. The method of claim 9, wherein the game of chance includes a lottery terminal connected to a network interface, and wherein the method includes receiving or inputting data using the lottery terminal.

18. The method of claim 9, further comprising entering data using an electronic interface, the interface being capable of supplying data by the use of a central processor.

19. The method of claim 9, further comprising identifying ticket characteristics that are printed on a ticket including the one or more player variables for the game of chance.

20. The method of claim 9, further comprising identifying a marker that is printed on a ticket including the one or more player variables for the game of chance; and
validating the ticket using the marker.
